(19) United States
(12) Patent Application Publication
(10) Pub. No.: US 2010/0026036 A1
(43) Pub. Date: Feb. 4, 2010

(54) SLIDING-BOW TARPAULIN SYSTEM

(76) Inventors: Udo WENSING, Oberhausen (DE); Hans Bods Hahnen, Kamp Lintfort (DE); Frank Neumeyer, (US); Frank Frentzen, (US); Rolf Birkenbach, Krafeid (DE); Ken Kemmerling, (US); Azel Scholz, (US); Tua Lauterbach, (US); Flor Weigelt, (US)

Correspondence Address: BERENATO & WHITE, LLC, 6550 ROCK SPRING DRIVE, SUITE 240, BETHESDA, MD, 20817, US

(21) Appl. No.: 12/478,869

(22) Filed: Jun. 5, 2009

(30) Foreign Application Priority Data
Jun. 6, 2008 (EP) 08010327.8

(51) Int. Cl. B60J 11/00

(52) U.S. Cl. 296/98

(57) ABSTRACT

The invention relates to a sliding-bow tarpaulin system for lorries or lorry trailers, with a plurality of runner and guide rails, which extend on the loading area of the lorry along the longitudinal sides of the loading area and in which roller carriages, with retaining bow members that are positioned thereon and are realized like portals, are displaceably guided, and with a tarpaulin attached to the retaining bow members.

In order to provide a sliding-bow tarpaulin system, where a tautening of the tarpaulin in the upper region is possible, at least one of the retaining bow members, in particular a retaining bow member that is not realized so as to be displaceable and/or is provided at one end of the loading area, is to be realized in its bottom region so as to be tiltable about a pivotal axis.

### CROSS-REFERENCE TO RELATED APPLICATIONS AND CLAIM TO PRIORITY

This application is related to application number 08010327.8, filed Jun. 6, 2008 with the European Patent Office, the disclosure of which is incorporated herein by reference and to which priority is claimed.

### FIELD OF THE INVENTION

The invention relates to a sliding-bow tarpaulin system for lorries or lorry trailers, with a plurality of runner and guide rails, which extend on the loading area of the lorry or lorry trailer along the longitudinal sides of the loading area and in which roller carriages, with retaining bow members that are positioned thereon and are realized like portals, are displaceably guided, and with a tarpaulin attached to the retaining bow members.

### BACKGROUND OF THE INVENTION

Such sliding-bow tarpaulin systems are known in practice and the majority are designed as described in DE 198 39 820 A1.

In operation there is both the loaded and the unloaded state and, on account of the different levels of load-deflection of the loading area, the result is that the top side of the tarpaulin is not tensioned tautly enough and consequently, at least in part regions, sags to a greater or lesser extent. This leads to adverse effects, such as, for example, noise nuisance, through flapping or similar when driving, and moisture can collect on the tarpaulin and this then has to be removed or can drop down at unsuitable moments. It is even more critical in winter when this collected moisture freezes and consequently falls to the ground in the form of ice.

It is the object of the invention to avoid the aforementioned disadvantages and to provide a sliding-bow tarpaulin system where a tautening of the tarpaulin in the top region is possible.

### SUMMARY OF THE INVENTION

This object is achieved in that at least one of the retaining bow members, in particular a retaining bow member that is not realized so as to be displaceable and/or is provided at one end of the loading area, is realized in its bottom region so as to be tiltable about a pivotal axis. This means that a horizontal displacement of the top region of said retaining bow member is effected, which means that a tautening of the top side of the tarpaulin can be effected, the bottom region of the tarpaulin, i.e. the bottom region of the lateral walls, is not influenced or is at least hardly influenced.

In an advantageous manner, in the case of at least one of the retaining bow members that is realized so as to be displaceable, the roller carriage can be realized so as to be fixedly securable, in particular fixedly clampable or lockable, in at least one position in the runner and guide rails, such that fixed positioning for example at one or also both of the respective ends of the loading area can be effected and the retaining bow members provided there when the vehicle is being driven are moveable away from this position for loading and/or unloading procedures.

According to the invention, in the case of at least one of the retaining bow members that is realized so as to be displaceable, the roller carriage can have play in the runner and guide rails and consequently can enable tipping to a small extent, such that by tipping the retaining bow member, a horizontal displacement of the top region is likewise possible and consequently a movement of the tarpaulin can be “entrained”.

The securement of the tarpaulin to the retaining bow members can also have play for this purpose, in particular ca. 1 cm or a few cm.

In an advantageous manner, the retaining bow member provided with a pivotal axis can have a device for obtaining a deflection force, which effects a pivoting of the retaining bow member, in particular in the direction opposing the extension of the tarpaulin, such that the pivoting at least in one pivoting direction does not have to be effected manually or by way of an auxiliary means or tool.

In this case the device for obtaining a deflection force can be realized as a resilient element, in particular as a resilient element exerting a compressive force, such as, for example, a compression spring, such that a deflection is possible without an additional power source, as would be necessary, for example, for electric or pneumatic or respectively hydraulic actuation.

The device for obtaining a deflection force can also be realized as a displacement element that is in particular manually actuatable, such as, for example, an eccentric, which means that a simple, tool-free actuation is possible.

In addition, a device can be provided for blocking the position of the retaining bow member, such as, for example, a few locking catches, such that an adjustable tautening in the top region of the tarpaulin is also effectable and, in particular, there is a possibility for reducing the tension for displacing the retaining bow member situated at the rear of the lorry or at the end of the lorry trailer.

In an advantageous manner, at least one retaining bow member can be provided, in the top region on at least one side, with an auxiliary bow member that in particular is pivotally secured, is hingeable to the retaining bow member and is realized like a portal, the length of said auxiliary bow member being realized such that its top transverse strut in the opened out state is at least approximately at the same level as the transverse strut of the retaining bow member, on which it is positioned, such that a better supporting of the tarpaulin at a plurality of points is provided.

### BRIEF DESCRIPTION OF THE FIGURES

An exemplary embodiment of the invention represented in the drawing is explained below, in which:

FIG. 1 shows a lorry trailer attached to a lorry traction engine, said trailer having a sliding-bow tarpaulin system according to the invention, and

FIG. 2 shows the detail “X” of the object in FIG. 1.

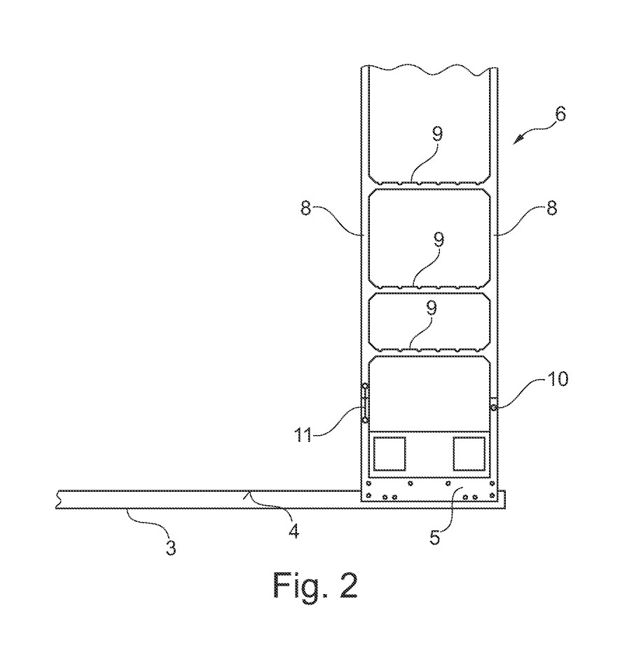

### DETAILED DESCRIPTION OF THE PREFERRED EMBODIMENT(S)

Corresponding references are used in all the figures for identical or respectively similar-type components.

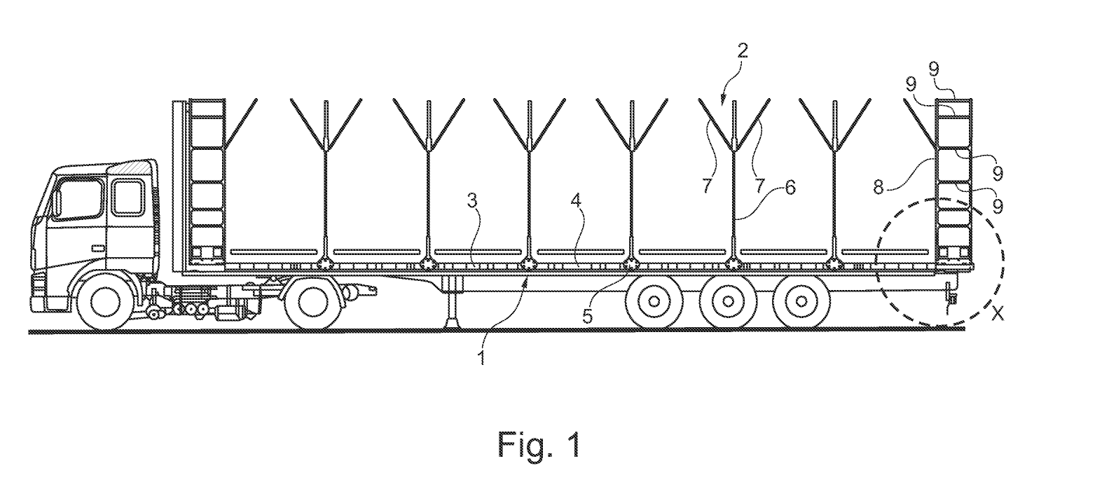

FIG. 1 shows a lorry trailer 1 with a sliding-bow tarpaulin system 2 with a plurality of runner and guide rails 4 that extend on the loading area 3 of the lorry trailer 1 along the longitudinal sides of the loading area 3. Roller carriages 5 with retaining bow members 6, which are positioned thereon and are realized like portals, are displaceably guided in the runner and guide rails 4, the retaining bow members 6, in the top region on both sides, each being provided with an auxiliary bow member 7, which is pivotally secured and realized like a portal, said auxiliary bow members being hingeable to the respective retaining bow member 6. The retaining and auxiliary bow members 6, 7 consequently span the width of the loading area 3 and, by means of their roller carriages 5, are positioned so as to be displaceable in the runner and guide rails 4.

The length of the auxiliary bow member 7, in this case, is developed such that its top transverse strut 7a, in the opened state, is at least approximately at the same height as the transverse strut 6a of that retaining bow member 6, on which the auxiliary bow member 7 is positioned.

The sliding-bow tarpaulin system 2 additionally includes a tarpaulin that is attached in the conventional manner to the retaining bow members 6 and the auxiliary bow members 7, said tarpaulin not being represented in the drawing for reasons of better clarity.

The retaining bow members 6 provided respectively at the front or respectively the rear end of the loading area 3 are realized here as end bow members, which, when viewed from the side, have a ladder-like design with two vertical struts 8 positioned spaced apart and extending perpendicularly in the runner and guide rails 4 and a plurality of said vertical struts 8 having horizontally interconnecting horizontal struts 9.

In order to enable a targeted tensioning of the tarpaulin substantially at its top side, the end bow member provided at the end of the lorry trailer 1 is realized in its bottom region so as to be tiltable about a pivotal axis 10.

The roller carriage 5 of said end bow member, in this case, is realized so as to be fixedly securable, in particular fixedly clampable or lockable, in at least this end position in the runner and guide rails.

In addition, said end bow member has a device 11 for obtaining a deflection force, which effects a pivoting of the retaining bow member into the direction opposing the extension of the tarpaulin, i.e. away from the traction engine towards the end of the lorry trailer, about the pivotal axis 10. In this case, the device 11 for obtaining a deflection force is realized as a resilient element that exerts a compressive force, such as, for example, a compression spring and a device 12 is provided for blocking the pivoted position of the retaining bow member.

We claim:

1. Sliding-bow tarpaulin system (2) for lorries or lorry trailers (1), with a plurality of runner and guide rails (4), which extend on the loading area (3) of the lorry or lorry trailer (1) along the longitudinal sides of the loading area and in which roller carriages (5), with retaining bow members (6) that are positioned thereon and are realized like portals, are displaceably guided, and with a tarpaulin attached to the retaining bow members (6), characterized in that at least one of the retaining bow members (6), in particular a retaining bow member (6) that is not realized so as to be displaceable and is provided at one end of the loading area (3), is realized in its bottom region so as to be tiltable about a pivotal axis (10).

2. Sliding-bow tarpaulin system (2) according to claim 1, characterized in that in the case of at least one of the retaining bow members (6) that is realized so as to be displaceable, the roller carriage (5) has play in the guide rails (4) and consequently enables tipping to a small extent.

3. Sliding-bow tarpaulin system (2) according to claim 2, characterized in that in the case of at least one of the retaining bow members (6) that is realized so as to be displaceable, the roller carriage (5) is realized so as to be fixedly securable, in particular fixedly clampable or lockable, in at least one position in the runner and guide rails (4).

4. Sliding-bow tarpaulin system (2) according to claim 1, characterized in that the securement of the tarpaulin to the retaining bow members (6) has play, in particular ca. 1 cm or a few cm.

5. Sliding-bow tarpaulin system (2) according to claim 1, characterized in that the retaining bow member (6) provided with a pivotal axis (10) has a device (11) for obtaining a deflection force, which effects a pivoting of the retaining bow member (6), in particular in the direction opposing the extension of the tarpaulin.

6. Sliding-bow tarpaulin system (2) according to claim 5, characterized in that the device (11) for obtaining a deflection force is realized as a resilient element, in particular as a resilient element exerting a compressive force, such as, for example, a compression spring.

7. Sliding-bow tarpaulin system (2) according to claim 4, characterized in that the device (11) for obtaining a deflection force is realized as a displacement element that is in particular manually actuatable, such as, for example an eccentric.

8. Sliding-bow tarpaulin system (2) according to claim 1, characterized in that a device (12) is provided for blocking the position of the retaining bow member (6), such as, for example, a few locking catches.

9. Sliding-bow tarpaulin system (2) according to claim 1, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

10. Sliding-bow tarpaulin system (2) according to claim 5, characterized in that the device (11) for obtaining a deflection force is realized as a displacement element that is in particular manually actuatable, such as, for example an eccentric.

11. Sliding-bow tarpaulin system (2) according to claim 2, characterized in that the securement of the tarpaulin to the retaining bow members (6) has play, in particular ca. 1 cm or a few cm.

12. Sliding-bow tarpaulin system (2) according to claim 3, characterized in that the securement of the tarpaulin to the retaining bow members (6) has play, in particular ca. 1 cm or a few cm.

13. Sliding-bow tarpaulin system (2) according to claim 2, characterized in that the retaining bow member (6) provided with a pivotal axis (10) has a device (11) for obtaining a deflection force, which effects a pivoting of the retaining bow member (6), in particular in the direction opposing the extension of the tarpaulin.

14. Sliding-bow tarpaulin system (2) according to claim 3, characterized in that the retaining bow member (6) provided with a pivotal axis (10) has a device (11) for obtaining a deflection force, which effects a pivoting of the retaining bow member (6), in particular in the direction opposing the extension of the tarpaulin.

15. Sliding-bow tarpaulin system (2) according to claim 4, characterized in that the retaining bow member (6) provided with a pivotal axis (10) has a device (11) for obtaining a deflection force, which effects a pivoting of the retaining bow member (6), in particular in the direction opposing the extension of the tarpaulin.

16. Sliding-bow tarpaulin system (2) according to claim 2, characterized in that a device (12) is provided for blocking the position of the retaining bow member (6), such as, for example, a few locking catches.

17. Sliding-bow tarpaulin system (2) according to claim 3, characterized in that a device (12) is provided for blocking the position of the retaining bow member (6), such as, for example, a few locking catches.

18. Sliding-bow tarpaulin system (2) according to claim 4, characterized in that a device (12) is provided for blocking the position of the retaining bow member (6), such as, for example, a few locking catches.

19. Sliding-bow tarpaulin system (2) according to claim 5, characterized in that a device (12) is provided for blocking the position of the retaining bow member (6), such as, for example, a few locking catches.

20. Sliding-bow tarpaulin system (2) according to claim 2, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

21. Sliding-bow tarpaulin system (2) according to claim 6, characterized in that a device (12) is provided for blocking the position of the retaining bow member (6), such as, for example, a few locking catches.

22. Sliding-bow tarpaulin system (2) according to claim 7, characterized in that a device (12) is provided for blocking the position of the retaining bow member (6), such as, for example, a few locking catches.

23. Sliding-bow tarpaulin system (2) according to claim 3, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

24. Sliding-bow tarpaulin system (2) according to claim 4, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

25. Sliding-bow tarpaulin system (2) according to claim 5, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

26. Sliding-bow tarpaulin system (2) according to claim 6, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

27. Sliding-bow tarpaulin system (2) according to claim 7, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.

28. Sliding-bow tarpaulin system (2) according to claim 8, characterized in that at least one retaining bow member (6) is provided, in the top region on at least one side, with an auxiliary bow member (7) that in particular is pivotally secured, is hingeable to the retaining bow member (6) and is realized like a portal, the length of said auxiliary bow member being realized such that its top transverse strut in the opened out state is at least approximately at the same level as the transverse strut of the retaining bow member (6), on which it is positioned.
